(19) United States
(12) Patent Application Publication
(10) Pub. No.: US 2005/0024224 A1
(43) Pub. Date: Feb. 3, 2005

(54) Electric hand lamp or emergency light applied to the transmitter for remote controlled vehicle security alarms

(76) Inventors: Juan Melchor Leal, Guadalajara (MX); Alejandro R. Malacara, Guadalajara (MX)

Correspondence Address: JUAN MELCHOR LEAL;c/o MALACARA & ASSOCIATES, S.C., 82 CHAPEL HILL CIRCLE, SAN ANTONIO, TX, 78240, US

(21) Appl. No.: 10/629,612

(22) Filed: Jul. 30, 2003

(51) Int. Cl. G08B 5/22

(52) U.S. Cl. 340/815.45

(57) ABSTRACT

The object of this Utility model consists in the addition of an electric hand lamp or emergency light function to a cordless transmitter that is used to remotely control the locking or unlocking of the vehicles doors and trunk, and/or and, in some cases, the antitheft security or alarm system, letting the possessor of the transmitter the advantage of having a source of illumination, without the necessity of carrying another device designed specifically to illuminate a dark area, or to generate a strong emergency light signal.

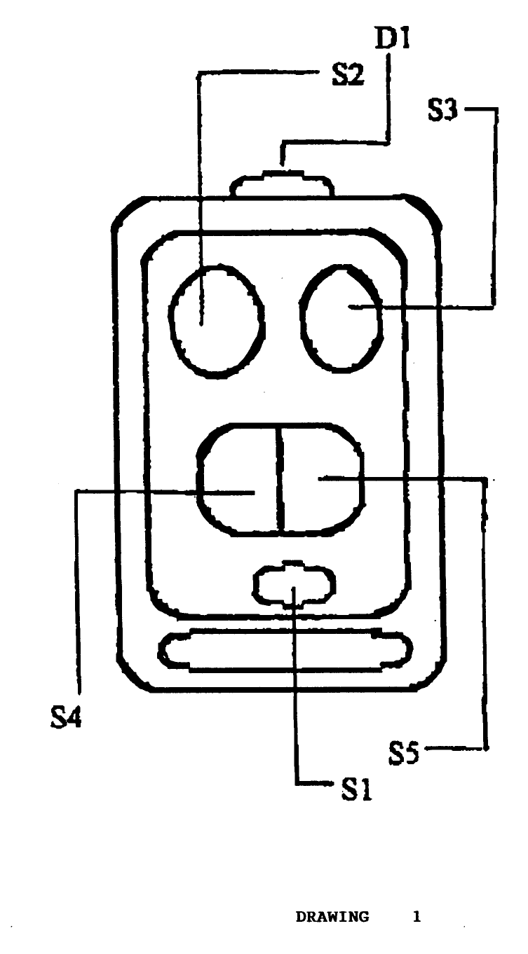

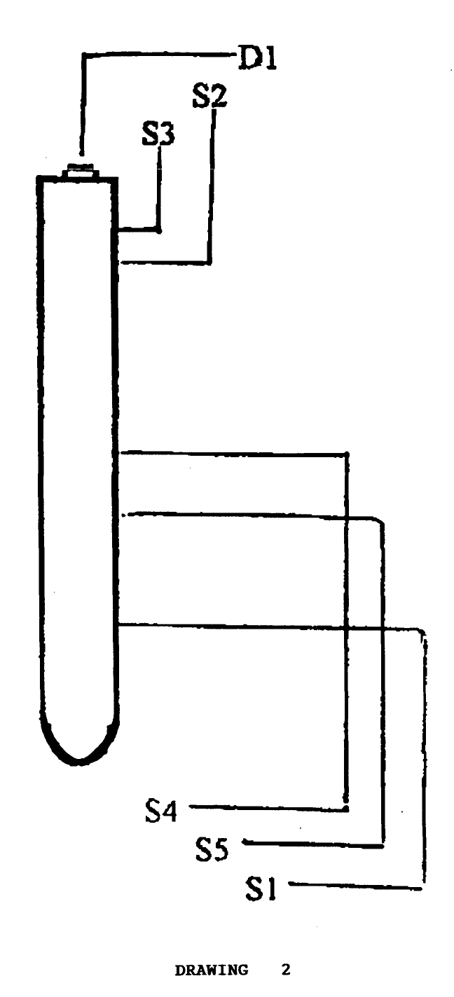

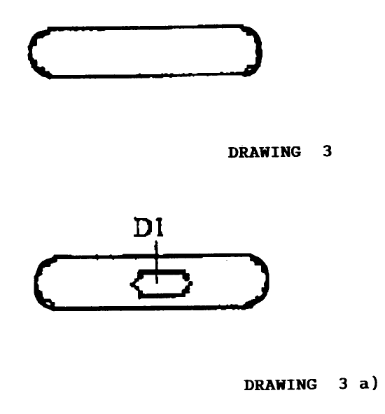

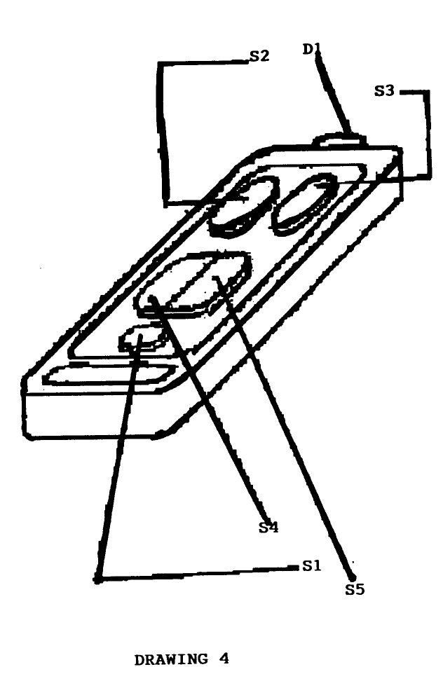

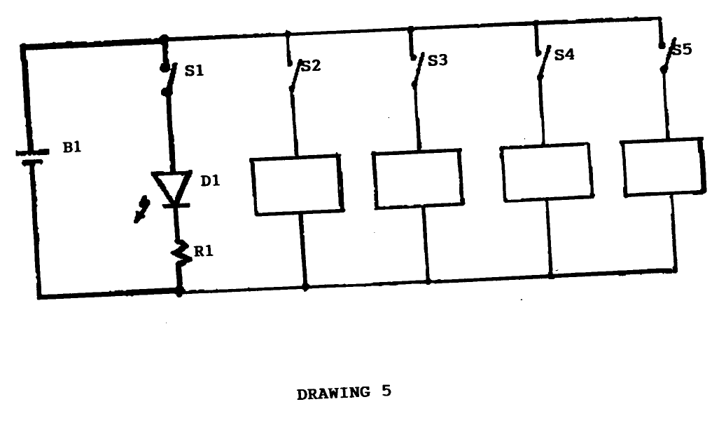

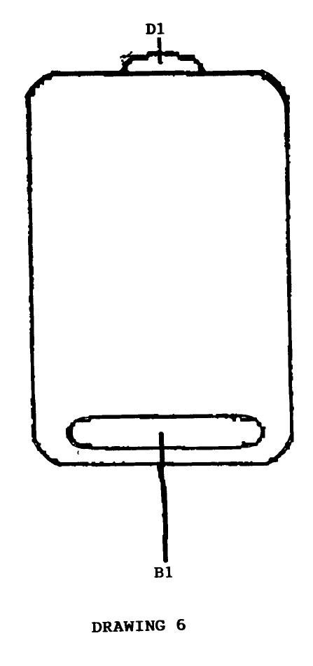

### OBJECT OF THE INVENTION

The object of this Utility model consists on the addition of an electric hand light or emergency light to a cordless transmitter that is used to remotely lock or unlock the vehicle's doors and/or trunk and, in some cases, the antitheft security or alarm system, letting the possessor of the transmitter the advantage of having a source of illumination, without the necessity to carry another device designed specifically to illuminate a dark area.

### ANTECEDENTS

In the course of the times the man has had the necessity of, with the arrival of the darkness or the absence of natural light, to look for a way of being provided with illumination for his diverse activities, obtaining such a result with fire at the beginning, and later with electric sources, like nowadays by mean of reduced size portable lighting devices.

For some time the manufacturing industries of automotive vehicles, antitheft security or alarm systems and accessories for vehicles, have provided the possessor and driver of them, with remote controlled vehicle security and/or alarm systems that allows, by means of the use of a wireless transmitter, to connect or to disconnect from distance some elements of comfort, security and antitheft alarms.

However, until the moment, such transmitters only had such specific function.

The utility Model hereinafter described confers to the transmitter an additional characteristic, of accommodate in their same structure and without affecting their size, weight and usefulness, a device that generates another different function and of supreme utility for multiple occasions: the advantage of also having a hand lamp without the space inconveniences and inherent weight of having to carry a traditional additional lamp.

The process for the creation of this hand lamp or emergency light system applied to remote control transmitters is essentially to place, in the parametric border of the transmitter case or in any other part of their case surface, a luminous light emitting diode (LED) or a group of LED's, to be used as a luminous source, and not as a function signal.

### DESCRIPTION OF THE INVENTION

As already mentioned, the process for the creation of this system of hand lamp or emergency light applied to transmitter of remote control is essentially to place in the parametric border of the transmitter case or in any part of their case surface, a light emitting diode or a group of them, with the advantage that it or they can be incorporated to anyone of the wireless transmitters, regardless of their brand name or their origin and without interfering in their original design and functions, since only their case and their energy source or battery (s) are used and there only two things are added:
A push button to close the electric circuit and that can be either used just for this specific function or to bring other combined function(s) plus the luminous function herein described.
A light emitting diode (LED) or a group of LED 's used as a light source.

The rest of the original design of the transmitter remains almost intact and without any significant alteration.

To accommodate both elements to the remote control transmitter, the injection molds for the transmitter case must be modified or built with one or more holes in order to place on it (they) the corresponding diode (es), in a way it (they) is (are) they are being part of the same. Also the respective circuit board will be included inside of the transmitter case.

Part of such circuit is the switch identified hereinafter as S1, which connects the battery B1 of the wireless transmitter to a light emitting diode D1, or to a group of light emitting diodes, during the time the circuit remains closed. When the circuit is opened D1 is turned off.

Depending on the operating voltage of the selected LED (s), the battery BI could be connected directly to D1 or through an electric resistance, RI, to cause the required voltage drop.

For a better understanding of this utility model I am attaching the following

### DRAWINGS

Where on:

DRAWING 1.—It can be seen, just as an example, and in case to be applied to a transmitter with this characteristic design it should not be considered as a limitation to the present invention, a plant view of a remote control transmitter.

DRAWING 2.—It can be seen, just as an example, and in case to be applied to a transmitter with this characteristic design it should not be considered as a limitation to the present invention, a lateral or side view of a remote control transmitter.

DRAWING 3 It can be seen, just as an example, and in case to be applied to a transmitter with this characteristic design it should not be considered as a limitation to the present invention, another side view of a remote control transmitter.

DRAWING 3-A.—It can be seen, just as an example, and in case to be applied to a transmitter with this characteristic design it should not be considered as a limitation to the present invention, another side view, opposite to the side shown in drawing 3. Of remote control transmitter.

DRAWING 4.—It can be seen, just as an example, and in case to be applied to a transmitter with this characteristic design it should not be considered as a limitation to the present invention, an isometric view of a remote control transmitter.

DRAWING 5: It can be seen, just as an example, and in case to be applied to a transmitter with this characteristic design it should not be considered as a limitation to the present invention, a block type electric diagram of a transmitter for remote controlled vehicle safety alarm, with some of their optional or possible functions. These functions can vary and are mentioned in an enunciatively way and not in a limitative way.

DRAWING 6.—It can be seen, just as an example, and in case to be applied to a transmitter with this characteristic design it should not be considered as a limitation to the present invention, a bottom or inferior view of a remote control transmitter.

According to these drawings it can be observed in drawing 5 that:

Pushbutton (S2), the same as all the remaining pushbuttons (S1, S3, S4 and S5) are momentary acting switches. S2 has two remote controlled functions:

It arms the antitheft security alarm system of the vehicle, and
It locks the vehicle doors.

Pushbutton (S3) disarms the antitheft security alarm system and unlocks the vehicle doors. Pushbutton (S4) is optional in some transmitters and wiressly disarms the antitheft security alarm system and unlocks the trunk.

Pushbutton (S5) is also optional in some transmitters and it is used to cordless send a signal in order the vehicle can generate an audible loud sound known as “panic”.

As an example they have been represented in the figures four electric pushbuttons switches (S2 to S5), but the number of these can vary without affecting the essence of the present invention.

When acted, switch (S1) closes the circuit connecting the battery (B1) of the wireless transmitter to a light emitting or to a group of light emitting diodes represented by (D1) either directly or, if necessary, by means of a resistance (R1), to cause a tension drop. The best well-known method or the best way supported by the applicant to carry out the invention claim, is the one that has been described previously.

1. It is claimed as of exclusive property of the applicant the system of electric hand light or emergency light applied to the transmitter for remote controlled vehicle security alarm system, obtained by placing in the parametric border of the transmitter case or in any part of their case surface, a light emitting diode or a group of light emitting diodes, with the advantage that it, or they, can be incorporated to anyone of the wireless transmitters, regardless of their brand name or their origin and without interfering with their original design and functions.

2. It is claimed as of exclusive property of the applicant the system of electric hand light or emergency light applied to the transmitter for remote controlled vehicle security alarms, with the characteristic that it can be incorporated to any of the cordless transmitters, regardless of their brand name or their origin and without interfering in their original design and functions, since it gets the power supply from the same transmitter batteries.

3. It is claimed as of exclusive property of the applicant the system of electric hand light or emergency light function applied to the transmitter for remote controlled vehicle security alarms, with the characteristic that it can be placed, in the parametric border of the transmitter case or in any part of their case surface, an electric switch specifically dedicated to close the electric circuit of the light emitting diode or a group of them or by means of a switch with combined functions.
